(19) United States
(12) Patent Application Publication
(10) Pub. No.: US 2020/0151911 A1
(43) Pub. Date: May 14, 2020

(54) AUTOMATIC CONTROL METHOD FOR PREVENTING EXPERIMENTAL DATA LOSS OF SPACE STATION

(71) Applicant: Beijing Space Quest Co., LTD., Beijing City (CN)

(72) Inventor: SUQUAN DING, Beijing City (CN)

(21) Appl. No.: 16/729,476

(22) Filed: Dec. 29, 2019

(30) Foreign Application Priority Data
May 24, 2019 (CN) 201910436367.0

(51) Int. Cl. G06T 7/90; G06T 7/33; B64G 1/42; B64G 1/44; B64G 1/46; B64G 1/24

(52) U.S. Cl. CPC G06T 7/90; G06T 7/33; B64G 1/242; B64G 1/44; B64G 1/46; B64G 1/428

(57) ABSTRACT

The automatic control method for preventing experimental data loss of space station includes: presetting shadow feature data cast by said target orbiting craft on said solar panels; detecting whether there is any target orbiting craft; acquiring a surface image of said solar panels after detecting the target orbiting craft; analyzing the acquired surface image of solar panels to detect whether there is any shadow feature data; starting power ensuring control for the environment control and life support system if the shadow feature data is detected; matching said shadow feature data with the above-mentioned preset shadow feature data cast by the target orbiting craft on said solar panels, wherein if they match each other, said experiment cabin is powered continuously to prevent data loss of the experiment cabin, which can effectively avoid unnecessary experimental data loss of the space station.

### FIELD OF THE INVENTION

The present invention relates to the aerospace technology field, and more particularly to an automatic control method for preventing loss of experimental data of a space station.

### BACKGROUND

A space station is also called as a spaceport. It is a manned spacecraft that runs in a near-earth orbit for a long time and is configured for visiting, long term work and life for multiple astronauts.

In general, a space station is powered by a solar panel for operation. When an orbiting craft is approaching the space station, the orbiting craft might cast its shadow on the solar panels, leading to reduced power supply. Due to the reduced supply of the solar panel, the control center of the space station will decrease the load to ensure power supply for the environmental control and life support system, thereby turning off experiment cabins that consumes much power, which would cause loss of data collected by the experiment cabins. However, the power supply reduction caused by the orbiting craft lasts for a short time during which the experiment cabins need not to be closed to cause unnecessary data loss of the cabins.

### SUMMARY OF THE INVENTION

The technical problem to be addressed by the present invention is to provide an automatic control method for preventing experimental data loss of a space station to avoid unnecessary experimental data loss of the space station.

In order to address the above technical problem, the present invention adopts the following technical solution.

An automatic control method for preventing experimental data loss of a space station is provided, said space station having solar panels, an experiment cabin powered by said solar panels and an environment control and life support system, wherein an experiment cabin acquires experimental data, said environment control and life support system controls to provide astronauts with basic life conditions and suitable working environment, the method including:

presetting shadow feature data cast by said target orbiting craft on said solar panels;

detecting whether there is an orbiting craft;

acquiring a surface image of said solar panels if the target orbiting craft is detected;

analyzing said acquired surface image of the solar panels to detect whether there is any shadow feature data;

starting power ensuring control for the environment control and life support system if any shadow feature data is detected;

matching said shadow feature data with said preset shadow feature data cast by the target orbiting craft on said solar panels, and continuing to power said experiment cabin to prevent data loss of said experiment cabin.

wherein, the preset shadow feature data cast by the target orbiting craft on said solar panels is the shadow distribution region data cast by said target orbiting craft on said solar panels.

wherein, analyzing said acquired surface image of the solar panels to detect whether there is any shadow feature data specifically includes:

subjecting the acquired surface image of the solar panels to gray scale and partitioning processing;

determining whether there is any shadow and shadow distribution region data according to the acquired gray values and partitioning values;

storing said determined shadow distribution region data as the shadow feature data.

Preferably, the method further includes: adjusting an attitude of the solar panels if the shadow feature data is detected to increase a shined area of the solar panels.

Preferably, the method further includes backing up experiment cabin data collected previously if the target orbiting craft is detected.

Preferably, the method further includes sounding an alarm to the control center of the space station if the target orbiting craft is detected.

As compared to prior art, the present invention has the following beneficial effects.

The present invention includes: presetting shadow feature data cast by said target orbiting craft on said solar panels; detecting whether there is any target orbiting craft; acquiring a surface image of said solar panels after detecting the target orbiting craft; analyzing the acquired surface image of solar panels to detect whether there is any shadow feature data; starting power ensuring control for the environment control and life support system if the shadow feature data is detected; matching said shadow feature data with the above-mentioned preset shadow feature data cast by the target orbiting craft on said solar panels, wherein if they match each other, said experiment cabin is powered continuously to prevent data loss of the experiment cabin, which can effectively avoid unnecessary experimental data loss of the space station.

### BRIEF DESCRIPTION OF DRAWINGS

FIG. 1 is a diagram of a solar panel applied to a space station according to the present invention;

FIG. 2 is a diagram showing distribution of shadows cast on the solar panel by the orbiting craft applied in the present invention;

FIG. 3 is a flow chart of an automatic control method for preventing experimental data loss of a space station applied in the present invention.

### DETAILED DESCRIPTION

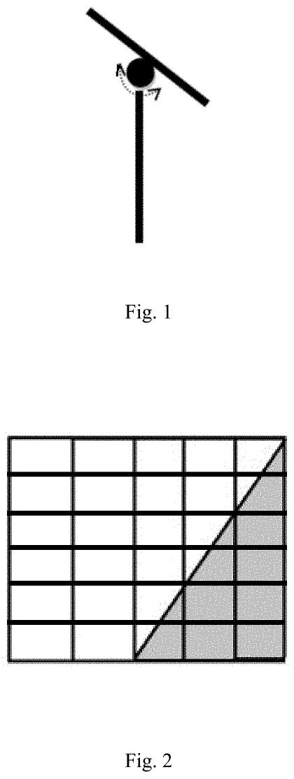

The space station of the present invention includes solar panels, an experiment cabin and an environmental control and life support system powered by said solar panel, in which the solar panels are devices for powering the spacecraft. Their working environment is the space near vacuum with extremely low external resistance. The solar panels feature large structure size, low rigidity and high flexibility and are generally composed by several solar cell panels, referring to FIG. 1, which is a diagram of a solar panel for a space station applied in the present invention. In addition, the experiment cabin is mainly for acquiring experimental data, and the environment control and life support system is mainly for controlling to provide basic life conditions and suitable work environment for astronauts. In practice, a space station further includes other functional systems which will not be described herein.

It is noted that an orbiting craft is an aerospacecraft flying in a predetermined space orbit that may provide transport service for the space station. The orbiting craft has a fixed volume and a fixed and regular flying trajectory. The operating trajectory of the solar panels is also regular. Therefore, the distribution regions of shadows cast by the orbiting craft onto the surfaces of the solar panels may be calculated in advance. For example, the shadow regions casted by the orbiting craft onto the solar panels may be calculated according to the modern astronomy algorithm proposed by the Belgium astronomer Jean Meeus, referring to FIG. 2, which is a diagram showing distribution of shadows cast by the orbiting craft onto the solar panels applied in the present invention. It is to be noted that this figure is just an example. In practice, when adjusting the flying trajectory of the solar panels and the flying attitude, distribution regions of shadows cast by the orbiting craft onto the solar panels change accordingly, which will not be described in detail herein.

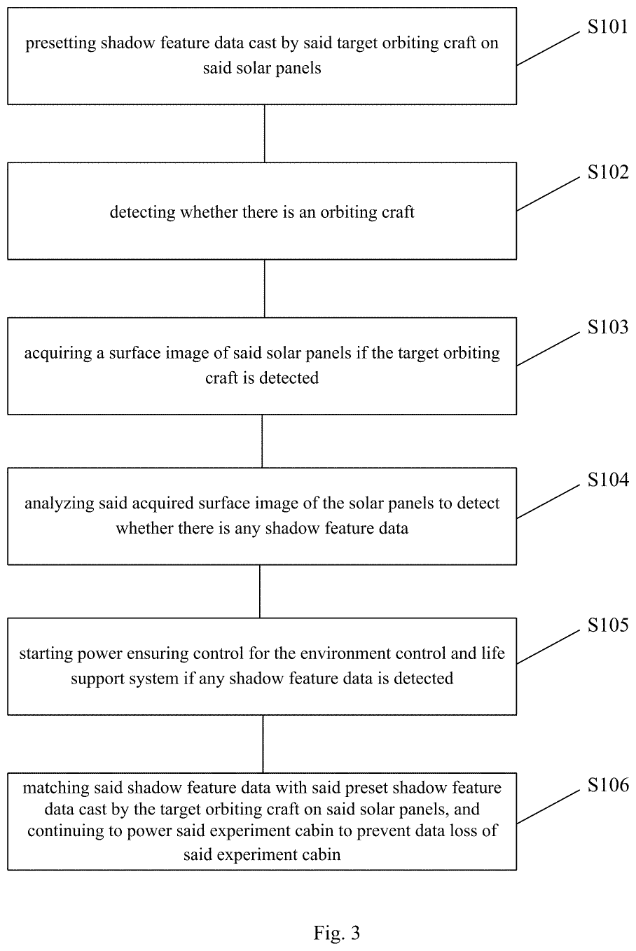

Referring to FIG. 3, which is a flow chart of an automatic control method for preventing experimental data loss of a space station applied in the present invention. Specifically, the automatic control method for preventing experimental data loss of a space station according to an embodiment of the present invention includes the following steps specifically:

S101, presetting shadow feature data cast by said target orbiting craft on said solar panels, wherein in specific implementation, it is possible to locate the projection of the target orbiting craft on said solar panels and acquire the shadow feature data at the corresponding location, said preset shadow distribution region data cast by said target orbiting craft on said solar panels is the shadow distribution region data cast by said orbiting craft on said solar panels, and in practice, the entire surface of the solar panels is divided into individual square or triangle grids (or other shapes of grids, which is not limited herein), the area of the square or triangle grid may be adjusted according to practical conditions, the square grids may be scaled down if high precision is required, and it is noted that the shadow distribution regions as shadow feature data in the present invention may be a range of the shadow distribution regions formed by the orbiting craft in the whole period, or a range of the shadow distribution region at an instance at which the orbiting craft forms the shadow;

S102, detecting whether there is an orbiting craft;

S103, acquiring a surface image of said solar panels after detecting the target orbiting craft;

S104, analyzing said acquired surface image of the solar panels to detect whether there is any shadow feature data, wherein in specific implementation, for example as an embodiment, the following may be used for determination:

subjecting the acquired surface image of the solar panels to gray scale and partitioning processing;

determining whether there is any shadow and shadow distribution region data according to the acquired gray values and partitioning values;

storing said determined shadow distribution region data as the shadow feature data;

wherein in specific implementation, for example, it is possible to use a normalized cross-correlation function to detect shadows and the location may be determined according to the above-described square grids for partitioning with each small square grid being one location point, the shadow distribution regions are located according to square grids where the shadows locate to obtain the shadow distribution region data; in addition, it is possible to acquire images from multiple angles by multiple cameras, and while analyzing the acquired surface image of the solar panel, it is possible to use the weighed average strategy algorithm to process image of the multiple angles, thereby realizing pixel-level fusion and improving accuracy;

S105, the power ensuring control for the environment control and life support system needs to be started if any shadow feature data is detected since the solar panel is shielded which may cause shortage of power supply;

S106, matching said shadow feature data with the preset shadow feature data cast by the target orbiting craft on said solar panel, wherein if they match, said experiment cabin will be powered continuously to prevent data loss of the cabin which may avoid unnecessary loss of experimental data, it is noted that during specific matching, it may be precise matching or fuzzy matching wherein precise matching is to precisely match shadow feature data detected at a predetermined instant with the preset shadow feature data at the predetermined instant, while the fuzzy matching is to match shadow feature data detected at a predetermined instant with the preset shadow feature data in the entire period during which the orbiting craft forms shadow (that is, the range of shadow distribution regions over the entire period during which the orbiting craft forms shadow) and it may be determined they match each other if only it is in the preset shadow distribution region range.

In addition, as a preferred embodiment, the present invention may further include: if the shadow feature data is detected, increasing the shined are of the solar panel by adjusting attitude of the solar panel, wherein when the shined area of the panel increases, the power supply amount of the solar panel increase accordingly, allowing the solar panel continue to power said experiment cabin to prevent data loss of the experiment cabin.

In addition, as another preferred embodiment of the present invention, the present invention further includes: backing up experiment cabin data acquired previously if a target orbiting craft is detected, wherein in specific implementation, if a target orbiting craft is detected, the experiment cabin might be powered off by the energy control system of the space station, therefore, if a target orbiting craft is detected, it is possible to back up data of the experiment cabin to prevent data loss.

In addition, as another preferred embodiment of the present invention, the present invention further includes: sounding alarm to the control center of the space station if any target orbiting craft is detected, wherein in specific implementation, if a target orbiting craft is detected, since the experiment cabin might be powered off by the energy control system, the control center of the space station may determine that power shortage is caused by the orbiting craft via alarming for a not long period, which allows continuing to power the experiment cabin by the solar panel to prevent data loss of the experiment cabin.

In addition, although the solar panel works in an environment near vacuum, it might be influenced by external interference such as particle streams and generate resonance. The resonance attenuates very slow, which causes inaccurate location of the solar panel. The present invention further includes disposing a resonance control element, a resonance sensor and a resonance controller on the solar panels. Said resonance sensor detects resonance signals. Said resonance controller determines resonance suppression signals according to the resonance signals transmitted from said resonance sensor and sends the resonance signals to the resonance control element. Said resonance control element generates an active control force according to the resonance suppression signals to suppress resonance, thereby suppressing resonance rapidly and allowing more accurate location of the solar panel.

What have been discussed above are only present inventions of the present invention and are not intended to limit the present invention. Any modifications, equivalent substitutions and improvements made in the spirit and principle of the present invention are all should be encompassed in the scope of the present invention.

What is claimed is:

1. An automatic control method for preventing experimental data loss of a space station, said space station having solar panels, an experiment cabin powered by said solar panels and an environment control and life support system, wherein an experiment cabin acquires experimental data, said environment control and life support system controls to provide astronauts with basic life conditions and suitable working environment, wherein the method comprises:
presetting shadow feature data cast by said target orbiting craft on said solar panels;
detecting whether there is an orbiting craft;
acquiring a surface image of said solar panels if the target orbiting craft is detected;
analyzing said acquired surface image of the solar panels to detect whether there is any shadow feature data;
starting power ensuring control for the environment control and life support system if any shadow feature data is detected;
matching said shadow feature data with said preset shadow feature data cast by the target orbiting craft on said solar panels, and continuing to power said experiment cabin to prevent data loss of said experiment cabin.

2. The automatic control method of claim 1, wherein the preset shadow feature data cast by the target orbiting craft on said solar panels is the shadow distribution region data cast by said target orbiting craft on said solar panels.

3. The automatic control method of claim 1, wherein said analyzing said acquired surface image of the solar panels to detect whether there is any shadow feature data specifically comprises:
subjecting the acquired surface image of the solar panels to gray scale and partitioning processing;
determining whether there is any shadow and shadow distribution region data according to the acquired gray values and partitioning values;
storing said determined shadow distribution region data as the shadow feature data.

4. The automatic control method of claim 1, further comprising: adjusting an attitude of the solar panels if the shadow feature data is detected to increase a shined area of the solar panel so as to increase power supply, allowing the solar panels to continue powering said experiment cabin to prevent data loss of said experiment cabin.

5. The automatic control method of claim 1, further comprising backing up experiment cabin data collected previously if the target orbiting craft is detected.

6. The automatic control method of claim 1, further comprising sounding alarm to a control center of the space station if the target orbiting craft is detected, allowing the control center of the space station to determine that solar panels continue powering said experiment cabin to prevent data loss of said experiment cabin.
